(19) United States
(12) Patent Application Publication
(10) Pub. No.: US 2008/0150748 A1
(43) Pub. Date: Jun. 26, 2008

(54) AUDIO AND VIDEO PLAYING SYSTEM

(76) Inventor: Markus Wierzoch, Taipei (TW)

Correspondence Address: BIRCH STEWART KOLASCH & BIRCH, PO BOX 747, FALLS CHURCH, VA, 22040-0747, US

(21) Appl. No.: 11/943,411

(22) Filed: Nov. 20, 2007

(30) Foreign Application Priority Data
Dec. 22, 2006 (TW) 095148639

(51) Int. Cl. G05B 19/02; G05B 19/00

(52) U.S. Cl. 340/825.22

(57) ABSTRACT

An audio and video playing system includes a controlling device and an audio and video playing device. The controlling device executes a movement. The audio and video playing device has an optical sensing unit and a processing unit. The optical sensing unit senses an image of the controlling device and outputs a signal to the processing unit. The processing unit recognizes the signal to determine the movement of the controlling device and outputs a corresponding control command to control the audio and video playing device.

### BACKGROUND OF THE INVENTION

1. Field of Invention

The invention relates to a playing system and, more particularly, to an audio and video playing system.

2. Related Art

With the development of the science and technology and the popularity of electronic products, an audio and video playing device has been one of important consumption electronic products.

Please refer to FIG. 1. Conventional sound equipment 1 includes a storage unit 11, a playing unit 12 and a display unit 13. The storage unit 11 is electrically connected to the playing unit 12, and the display unit 13 is electrically connected to the playing unit 12. Herein, the storage unit 11 is used to put audio data such as a compact disk or a tape, the playing unit 12 is used to read and play the audio data which is put in the storage unit 1, and the display unit 13 is used to display the data that the playing unit 12 is playing, so that users can know the playing status of the sound equipment 1.

Nowadays, a remote controller has been developed to control the operation of the sound equipment 1, so that a user can control the sound equipment 1 without approaching to the sound equipment 1. However, a user can control the sound equipment 1 only by pressing keys, and this method for selecting the audio playing status is too systematical and unfit for the need of consumers who seeks the new and change now.

Electronic products need not only functions now, the design and form are also main factors affecting the behavior of consumers. Therefore, how to show diverse product forms as well as new audio and image playing controlling method has been one of important subjects.

### SUMMARY OF THE INVENTION

One objective of the invention is to provide an audio and video playing system which has a new audio and video playing controlling method and diverse product forms.

To obtain the above objective, an audio and video playing system of the invention includes a controlling device and an audio and video playing device. The controlling device executes a movement. The audio and video playing device has an optical sensing unit and a processing unit. The optical sensing unit senses the image of the controlling device and outputs a signal to the processing unit, and the processing unit recognizes the signal to determine the movement of the controlling device and outputs a corresponding command to control the audio and video playing device.

To obtain the above objective, an audio and video playing system of the invention includes a controlling device and an audio and video playing device. The controlling device executes a movement. The audio and video playing device has a transmitting unit, a receiving unit and a processing unit. The transmitting unit transmits an ultrashort radio wave or a supersonic to the controlling device. The receiving unit receives a reflected wave of the controlling device and outputs a signal to the processing unit. The processing unit recognizes the signal to determine the movement of the controlling device and outputs a corresponding controlling command to control the audio and video playing device.

As stated above, the audio and video playing system of the invention controls the audio and video playing device according to the movement of the controlling device. That is, the audio and video playing device senses the movement of the controlling device and carries out the operation of turning on, turning off, fast forwarding, reversing, pausing, stopping, turning volume down or turning volume up. Compared with the conventional technology, the audio and video playing system of the invention can provide new audio and video playing controlling method and diverse product forms.

### BRIEF DESCRIPTION OF THE DRAWINGS

FIG. 1 is a schematic diagram showing conventional sound equipment.

FIG. 2 is a schematic diagram showing an audio and video playing system of one preferred embodiment of the invention.

FIG. 3 is a block diagram showing an audio and video playing system of one preferred embodiment of the invention.

FIG. 4 is a block diagram showing another audio and video playing system of one preferred embodiment of the invention.

FIG. 5A to FIG. 5D are schematic diagrams showing the detailed operation of an audio and video playing system of one preferred embodiment of the invention.

FIG. 6 is a block diagram showing another audio and video playing system of one preferred embodiment of the invention.

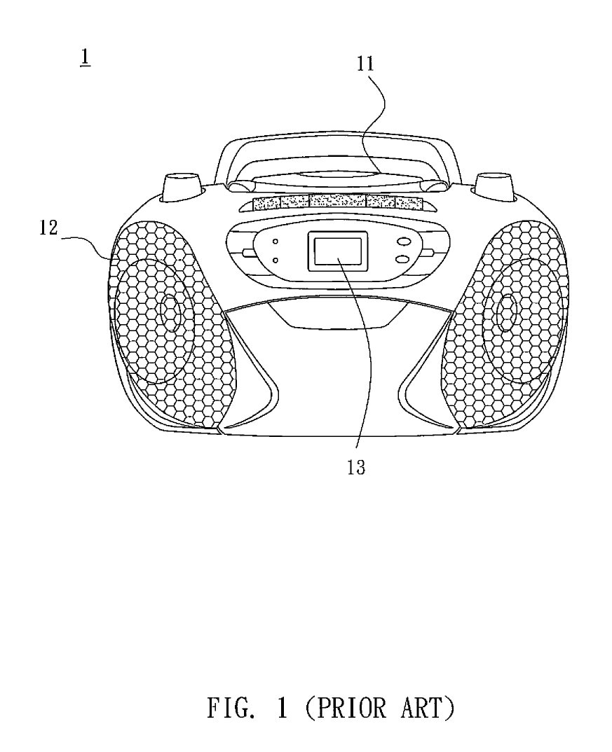

### DETAILED DESCRIPTION OF THE INVENTION

The audio and video playing system of one preferred embodiment of the invention will be described with the relative drawings. The same elements are denoted by the same reference numbers for convenience.

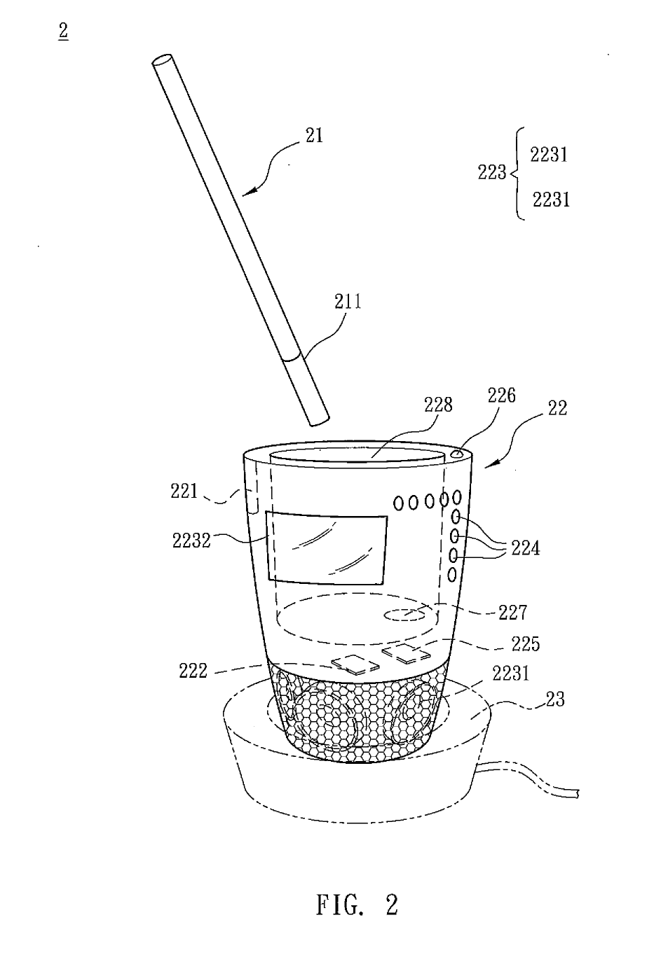

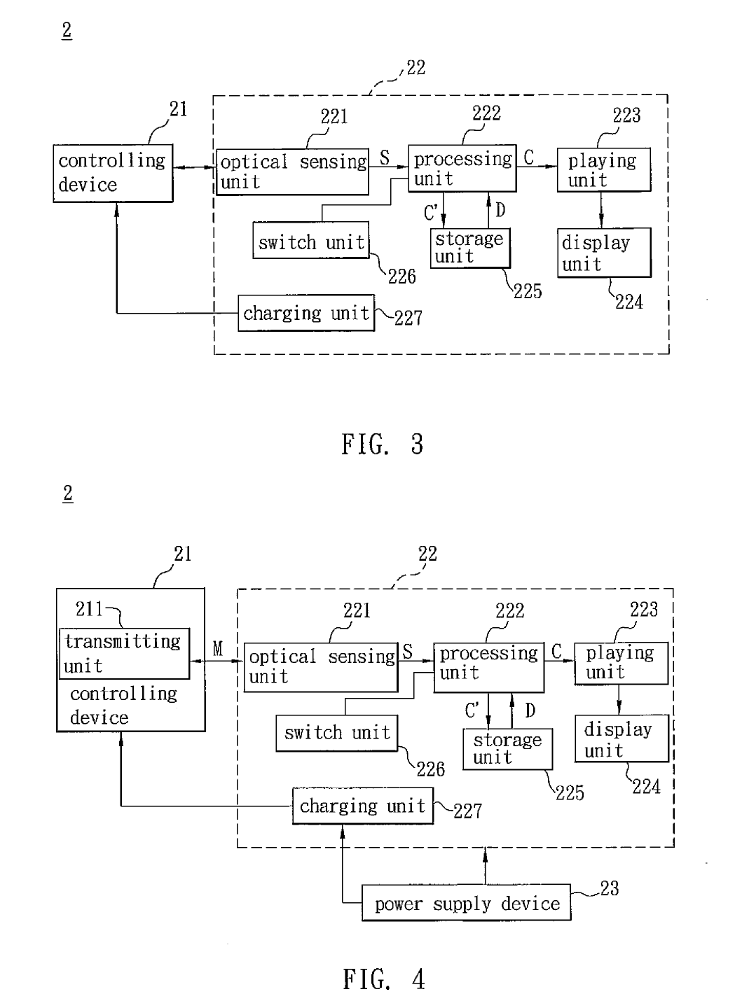

Please refer to FIG. 2 and FIG. 3. The preferred embodiment of the invention discloses an audio and video playing system 2 which includes a controlling device 21 and audio and video playing device 22. Herein, the controlling device 21 is used to control the audio and video playing device 22.

To make the description more convenient, the audio and video playing device 22 is, for example, sound equipment, but there is no limitation herein.

In this embodiment, the audio and video playing device 22 has an optical sensing unit 221, a processing unit 222, a playing unit 223, a display unit 224 and a storage unit 225. The optical sensing unit 221, the playing unit 223, the display unit 224 and the storage unit 225 are electrically connected to the processing unit 222, respectively.

When users wave the controlling device 21 to control the audio and video playing device 22, the optical sensing unit 221 can capture the image of the controlling device 21 and output at least one signal S to the processing unit 222, and the processing unit 222 recognizes the signal S to determine the movement of the controlling device 21 and produces a corresponding controlling command C to control the operation of the audio and video playing device 22. The operation is, for example, turning on, turning off, playing, fast forwarding, reversing, pausing, stopping, turning volume up or turning volume down. Herein, the optical sensing unit 221 of the audio and video playing device 22 can be a camera, a sensor or any element which can detect and capture image data to capture the image produced by the controlling device 21.

For example, when the optical sensing unit 221 is a camera, and the controlling device 21 does a movement, the camera can detect and capture the image change of the controlling device 21 and convert it to a signal S (the signal S is an image signal at this time) to transmit to the processing unit 222. The processing unit 222 can determine the movement of the controlling device 21 according to the position change of the controlling device 21 by an image recognition method and output a corresponding controlling command C. Therefore, the optical sensing unit 221 and the processing unit 222 can control the operation of the audio and video playing device 22 according to the movement of the controlling device 21 by the above method. However, the implementing form of this embodiment is not limited to the above method, and any method for positioning and determining by image data belongs to the range of this embodiment.

Please refer to FIG. 4. The controlling device 21 of this embodiment can further has a transmitting unit 211 which can transmit a light wave signal M such as an infrared light wave signal, an ultraviolet light wave signal or a light wave signal with other wavelength. That is, the transmitting unit 211 can be an infrared light transmitter or an ultraviolet light transmitter, and so on. Correspondingly, the optical sensing unit 221 can be a light wave sensor which can receive light wave signals (such as an infrared light receiver or an ultraviolet light receiver, and so on) or a camera having a light filtering function.

For example, when the transmitting unit 211 transmits an infrared light wave signal M, the optical sensing unit 221 (infrared light receiver) receives the light wave signal M and converts it to an electrical signal S to transmit to the processing unit 222. The processing unit 222 can know the position change, moving direction and moving speed of the controlling device 21 according to the electrical signal S to determine the movement of the controlling device 21 and to output a corresponding controlling command C to control the operation of the audio and video playing device 22.

Both the optical sensing unit 221 and the transmitting unit 211 can have an array form. That is, the number of both the transmitting unit 211 and the optical sensing unit 221 are more than two.

Please refer to FIG. 2 and FIG. 3. The playing unit 223 of the audio and video playing device 22 can comprise a loudspeaker 2231, a display panel 2232 or any element having a playing function to play audio and video data D stored in the storage unit 225 according to the controlling command C transmitted by the processing unit 222. Before the audio and video data D is played, the processing unit 222 transmits a controlling command C′ to obtain the audio and video data D which will be played.

The display unit 224 of this embodiment is used to display the playing status of the playing unit 223. That is, the data that the display unit 224 shows can make users know the operation status of the audio and video playing device 22. The display unit 224 can be a light emitting diode array (LED) or a small area liquid crystal display (LCD) panel, and so on.

The processing unit 222 and the storage unit 225 can be integrated in a processor. Of course, it can be adjusted according to the actual demand.

The audio and video playing device 22 of the embodiment further has a switch unit 226 which is electrically connected to the processing unit 222. When users apply a external force on the switch unit 226 (for example, when users use the controlling device 21 to knock the switch unit 226,) the audio and video playing device 22 turns the power supply on or turns the power supply off.

The audio and video playing device 22 of the embodiment further has a charging unit 227 and an accommodating room 228. When users do not use the controlling device 21, they can place the controlling device 21 in the accommodating room 228 to avoid losing. The charging unit 227 can also be provided in the accommodating room 228, so that when the controlling device 21 is placed in the accommodating room 228, the controlling device 21 can be charged.

Please refer to FIG. 2 and FIG. 3. The audio and video playing system 2 of this embodiment further has a power supply device 23. The power supply device 23 can be electrically connected to the audio and video playing device 22 to supply the audio and video playing device 22 with the power supply needed in the operation. In the embodiment, the power supply device 23 is provided outside the audio and video playing device 22. Of course, the power supply device 23 also can be provided inside the audio and video playing device 22 and be electrically connected to the outside power supply via a wire.

In this embodiment, the controlling device 21 is, for example, rod-shaped, but there is no limitation thereon. The exterior appearance and the shape of controlling device 21 can be changed according to the actual demand. The audio and video playing device 22 is, for example, container-shaped, but there is no limitation thereon. The exterior appearance and the shape of the audio and video playing device 22 also can be changed according to the actual demand.

The detailed operation way of the audio and video playing system 2 of the embodiment will be described with examples, so that the technical features of the invention will be clearer. The content hereinbelow is just used for explaining instead of limiting.

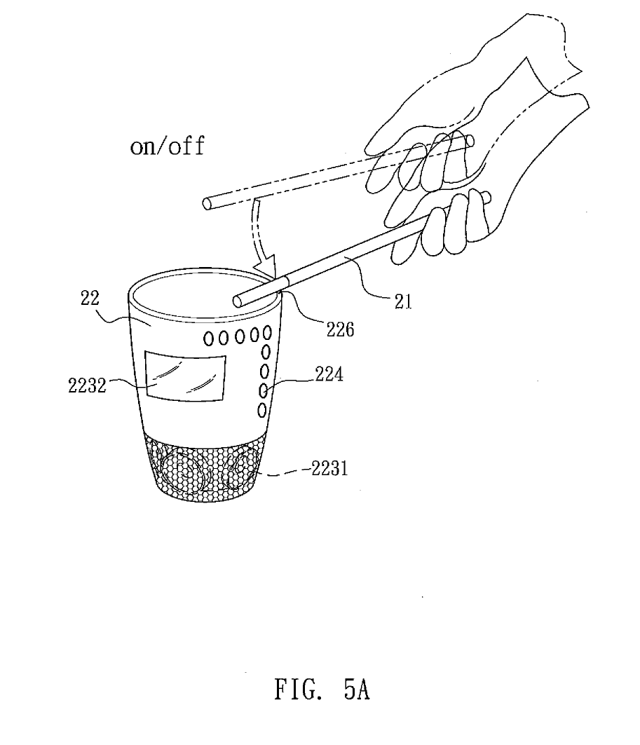

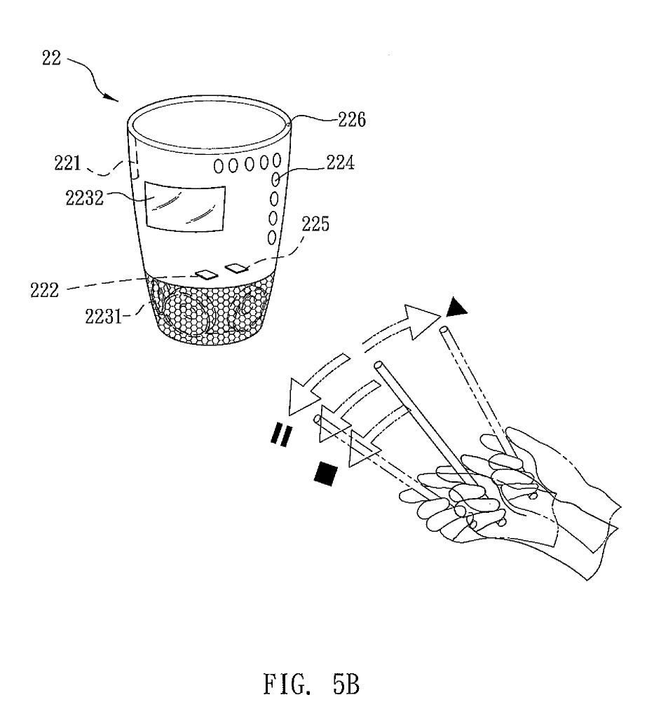

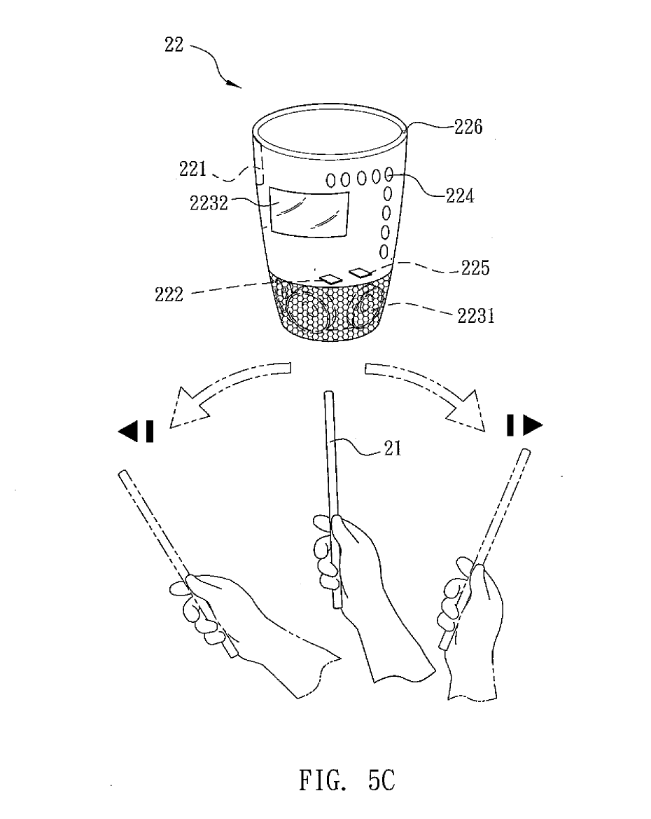

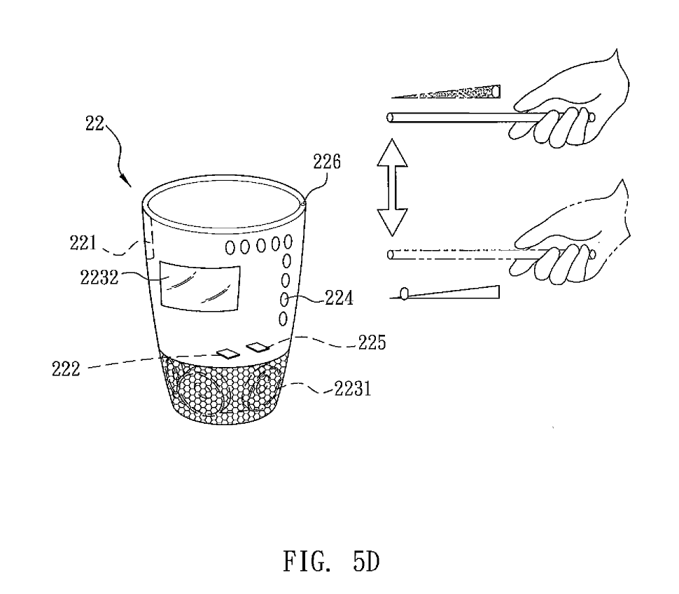

Please refer to FIG. 5A. When a user wants to play audio and video data D, he can use the controlling device 21 to knock the switch unit 226 of the audio and video playing device 22 to turn on the power supply of audio and video playing device 22. At this moment, the optical sensing unit 221 of the audio and video playing device 22 can start receiving the light wave signal M transmitted by the transmitting unit 211 in the controlling device 21. On the contrary, when the user want to turn off the audio and video playing device 22, he can use the controlling device 21 to knock the switch unit 226 of the audio and video playing device 22 again, so that the audio and video playing device 22 will turn off the power supply of itself, and end the receiving operation of the optical sensing unit 221.

Please refer to FIG. 5B, FIG. 5C and FIG. 5D. When the power supply of the audio and video playing device 22 is turned on, the audio and video playing device 22 will do the operation such as turning on, turning off, playing, fast forwarding, reversing, pausing, stopping, turning volume up or tuning volume down according to the movement of the controlling device 21.

Please refer to FIG. 5B. When the audio and video playing device 22 is turned on, and the user waves the controlling device 21 upward, the optical sensing unit 221 of the audio and video playing device 22 senses the light wave signal M and transmits the signal (electrical signal) s to the processing unit 222. The processing unit 222 determines the upward movement of the controlling device 21 and transmits a controlling command C to the playing unit 223 to carry out the operation of playing and displaying the playing data.

When the user waves the controlling device 21 downward, the optical sensing unit 221 of the audio and video playing device 22 receives the light wave signal M and transmits a signal (electrical signal) S to the processing unit 222, and the processing unit 222 determines the downward movement of the controlling device 21 and transmits a controlling command C to the playing unit 223 to carry out the operation of pausing. When the user waves the controlling device 21 downward twice quickly, the optical sensing unit 221 of the audio and video playing device 22 receives the light wave signal M and transmits a signal (electrical signal) S to the processing unit 222. The processing unit 222 determines the downward movement twice of the controlling device 21 and transmits a controlling command C to the playing unit 223 to carry out the operation of stopping.

The upward movement of the controlling device 21 can make the audio and video playing device 22 carry out the operation of playing, while the downward movement once or several times of the controlling device 21 can make the audio and video playing device 22 carry out the operation of pausing or stopping playing, and so on.

Please refer to FIG. 5C. When the user waves the controlling device 21 rightward, as stated above, the processing unit 222 can determine the rightward movement of the controlling device 21 and transmit a controlling command C to the playing unit 223 to carry out the operation of fast forwarding. When the user waves the controlling device 21 leftward, as stated above, the playing unit 223 will carry out the operation of turning round.

Please refer to FIG. 5D. When the user moves the controlling device 21 upward horizontally, as stated above, the processing unit 222 can determine the horizontally upward movement of the controlling device 21 and transmit the controlling command C to the playing unit 223 to carry out the operation of turning volume up. When the user moves the controlling device 21 downward horizontally, as stated above, the processing unit 222 can determine the horizontally downward movement of the controlling device 21 and output the controlling command C to the playing unit 223 to carry out the operation of turning volume down.

The above is used for taking an example instead of limiting. Each movement of the controlling device 21 corresponds to the operation carried out by the playing unit 223 can be adjusted according to the actual situation.

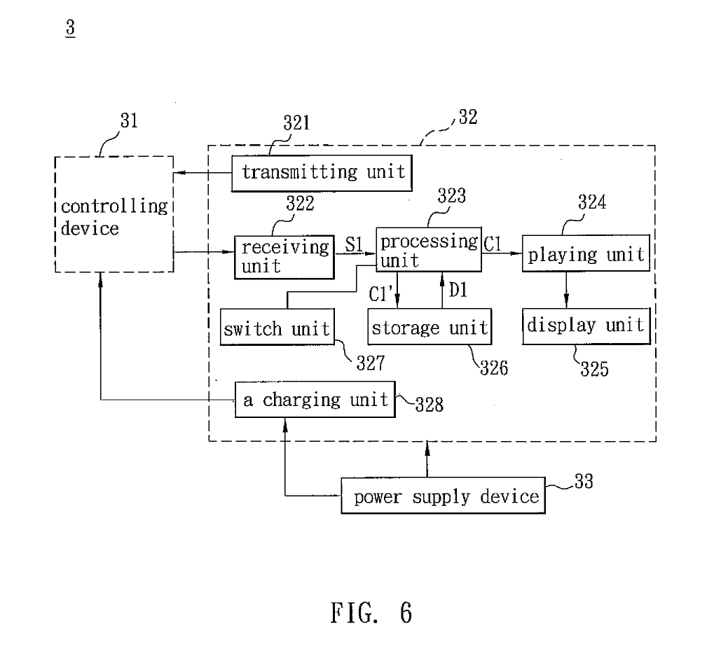

Please refer to FIG. 6. FIG. 6 shows another embodiment of the invention which provides an audio and video playing system 3 including a controlling device 31 and an audio and video playing device 32. The audio and video playing device 32 has a transmitting unit 321, a receiving unit 322 and a processing unit 323. The transmitting unit 321 transmits an ultrashort radio wave or a supersonic to the controlling device 31. The receiving unit 322 receives a reflected wave of the controlling device 31 and outputs a signal S1 to the processing unit 323. The processing unit 323 recognizes the signal S1 to determine the movement of the controlling device 31 and outputs a corresponding controlling command C1 to control the audio and video playing device 32 to play audio and video data D1.

In this embodiment, the audio and video playing system 3 further comprises a playing unit 324, a display unit 325, a storage unit 326, a switch unit 327, and a charging unit 328.

In addition, the audio and video playing system 3 further comprises a power supply device 33.

Herein, the features and functions of the controlling device 31, the processing unit 323, the playing unit 324, the display unit 325, the storage unit 326, the switch unit 327, the charging unit 328 and the power supply device 33 are the same with those of the same elements of the above embodiment. Therefore, they will not be described for concise purpose.

In this embodiment, the transmitting unit 321 can be an ultrashort radio wave transmitter or a supersonic transmitter. The receiving unit 322 can be an ultrashort radio wave receiver or a supersonic receiver.

For example, when the transmitting unit 321 transmits an ultrashort radio wave in the controlling device 31, the produced reflected wave is transmitted back to the audio and video playing device 32 and received by the processing unit 323. The receiving unit 322 outputs a signal S1 to the processing unit 323. The processing unit 323 recognizes the signal S1 to determine the movement of the controlling device 31. That is, the processing unit 323 can determine the movement of the controlling device 31 by processes of imaging, calculating, and so on, which is the same with the principle of the ultrashort wave radar. In addition, when the transmitting unit 321 transmits a supersonic, the supersonic displaying technology also can be used to determine the movement of the controlling device 31.

Of course, the audio and video playing device of the invention also can be a display, a recording and playing device, and so on. However, there is on limitation thereon.

To sum up, the audio and video playing device of the invention can detect the movement of the controlling device by the image recognizing method, displaying technology or positioning detecting method, so that users can use the controlling device to control the audio and video playing device.

From the above, the audio and video playing system of the invention controls the audio and video playing device according to the movement of the controlling device. That is, when the audio and video playing device senses the movement of the controlling device, it can do the operation of the turning on, turning of, playing, fast forwarding, reversing, pausing, stopping, turning volume up or turning volume down. Compared with the conventional technology, the audio and video playing system of the invention can provide a new audio and video playing controlling method and diverse product forms.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An audio and video playing system comprising:
a controlling device executing a movement; and
an audio and video playing device having an optical sensing unit and a processing unit, wherein the optical sensing unit senses the image of the controlling device and outputs a signal to the processing unit, and the processing unit recognizes the signal to determine the movement of the controlling device and outputs a corresponding controlling command to control the audio and video playing device.

2. The audio and video playing system according to claim 1, wherein the optical sensing unit is a camera.

3. The audio and video playing system according to claim 1, wherein the controlling device has a transmitting unit, and the transmitting unit transmits a light wave signal.

4. The audio and video playing system according to claim 1, wherein the optical sensing unit is a light wave sensor or a camera having a light filtering function.

5. The audio and video playing system according to claim 1, wherein the controlling command controls the audio and video playing device to play audio and video data.

6. The audio and video playing system according to claim 5, wherein the audio and video playing device further comprises:
a playing unit electrically connected to the processing unit to play the audio and video data.

7. The audio and video playing system according to claim 6, wherein the playing unit is a loudspeaker or a display panel.

8. The audio and video playing system according to claim 5, wherein the audio and video playing device further comprises:
a storage unit which is electrically connected to the processing unit and stores the audio and video data.

9. The audio and video playing system according to claim 1, wherein the controlling command controls the audio and video playing device to do operation of turning on, turning off, playing, fast forwarding, reversing, pausing, stopping, turning volume up or turning volume down.

10. The audio and video playing system according to claim 1, wherein the audio and video playing device further comprises:
a switch unit, wherein when an external force is applied on the switch unit, the audio and video playing device turns the power supply on or turns the power supply off.

11. The audio and video playing system according to claim 1, wherein the audio and video playing device further comprises:
a charging unit for charging the controlling device.

12. An audio and video playing system comprising:
a controlling device executing a movement; and
an audio and video playing device having a transmitting unit, a receiving unit and a processing unit, wherein the transmitting unit transmits an ultrashort radio wave or a supersonic to the controlling device, the receiving unit receives a reflected wave of the controlling device and outputs a signal to the processing unit, and the processing unit recognizes the signal to determine the movement of the controlling device and outputs a corresponding controlling command to control the audio and video playing device.

13. The audio and video playing system according to claim 12, wherein the controlling command controls the audio and video playing device to play audio and video data.

14. The audio and video playing system according to claim 13, wherein the audio and video playing device further comprises:
a playing unit electrically connected to the processing unit to play the audio and video data.

15. The audio and video playing system according to claim 14, wherein the playing unit is a loudspeaker or a display panel.

16. The audio and video playing system according to claim 13, wherein the audio and video playing device further comprises:
a storage unit which is electrically connected to the processing unit and stores the audio and video data.

17. The audio and video playing system according to claim 12, wherein the controlling command controls the audio and video playing device to do operation of turning on, turning off, playing, fast forwarding, reversing, pausing, stopping, turning volume up or turning volume down.

18. The audio and video playing system according to claim 12, wherein the audio and video playing device further comprises:
a switch unit, wherein when an external force is applied on the switch unit, the audio and video playing device turns the power supply on or turns the power supply off.

19. The audio and video playing system according to claim 12, wherein the audio and video playing device further comprises:
a charging unit for charging the controlling device.
